(19) United States
(12) Patent Application Publication
(10) Pub. No.: US 2010/0127020 A1
(43) Pub. Date: May 27, 2010

(54) PUMP DISPENSER

(76) Inventor: Tetsuya Tada, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 12/452,814

(22) PCT Filed: Jun. 24, 2008
(86) PCT No.: PCT/JP2008/061480

§ 371 Date: Jan. 22, 2010

(30) Foreign Application Priority Data
Jul. 23, 2007 (JP) 2007 191486

(51) Int. Cl. G01F 11/00; B65D 88/54

(52) U.S. Cl. 222/321.9; 222/341

(57) ABSTRACT

A push-type dispenser which has a cylinder as thin as possible and is free from deformation is provided. A pump dispenser (A) has a cylinder (1), a piston (4) slidably attached to the cylinder (1) from inside, and a nozzle head (2) having a nozzle opening (N) coupled to the piston (4). The pump dispenser discharges liquid from the nozzle opening (N) by applying a pressure to the liquid filling the interior of the cylinder (1) by pushing the nozzle head (2), wherein the wall of the cylinder has a thickness of 0.6 mm to 1.3 mm.

### TECHNICAL FIELD

The present invention relates a pump dispenser which discharges a certain amount of liquid, which is in a container.

Particularly, the present invention relates to a push-type dispenser which has a cylinder having a thickness as thin as possible and is free from deformation.

### BACKGROUND ART

Conventionally, a pump-equipped container has been used for discharging a certain amount of liquid such as a detergent, medicinal agent, etc.

The pump-equipped container is provided with a discharge mechanism, i.e., a pump dispenser, and, as an example thereof, a push-type pump dispenser, etc. are widely known (see Patent Document 1).

In this dispenser, when a piston is pushed down, a pressure is applied to the liquid which is sucked up into a cylinder via a suction tube, and the liquid is discharged from an opening of a nozzle head.

However, the cylinder, which is integrally formed with the suction tube, is preferred to have a smaller total amount of resin in terms of weight, material cost, etc.

Particularly, currently, usage of a pump dispenser having a large capacity and a large discharge amount (for example, 10 cc/one push), which requires a large total amount of resin, is becoming common, and the wall of the cylinder is strongly required to be thin as much as possible.

On the other hand, when the thickness of the cylinder is reduced, deformation is readily caused in the cross section of the cylinder. Therefore, there are drawbacks that “liquid leakage” or “air inclusion” occurs between the cylinder and the piston.

Herein, “liquid leakage” is a phenomenon that liquid leaks from a liquid region of the cylinder to an air region via the part between the cylinder wall surface and the piston due to pressurization in the cylinder, and “air inclusion” is a phenomenon that air leaks from the air region of the cylinder to the liquid region via the part between the cylinder wall surface and the piston due to negative pressure in the cylinder.

However, under present circumstances, empirically, the wall of the cylinder is caused to have a thickness of 1.5 mm or more by excessively using the total resin amount of the material in order to avoid the above described problems.

Today, from the viewpoint of the amount of used materials or cost, the thinner, the better.

The cylinder having the minimum thickness that can be achieved has not existed currently.

### Patent Document 1: Japanese Patent Application Laid-Open Publication No. 2002-200443

### DISCLOSURE OF THE INVENTION

### Problems to be Solved by the Invention

The present invention has been accomplished based on such technical background and accomplished for solving the above described problems of the conventional techniques.

Therefore, it is an object of the present invention to provide a push-type dispenser having a cylinder as thin as possible, which has not been conventionally used, and free from deformation.

The present inventor diligently carried out studies based on such technical background, and, as a result, found out that when the thickness was equal to or less than a certain thickness, deformation was readily generated in the cross section of the cylinder, and the liquid leakage or air inclusion phenomenon occurred. Based on this finding, the present inventor accomplished the present invention.

Thus, the present invention resides in (1) a pump dispenser having a cylinder and a piston slidably attached to the cylinder from inside, the pump dispenser discharging liquid from a nozzle head coupled to a piston by applying a pressure by the piston to the liquid filling the interior of the cylinder, characterized in that the wall of the cylinder has a thickness of 0.6 mm to 1.3 mm.

The present invention resides in (2) a pump dispenser having a cylinder integrally having a suction tube; a cap for attaching the cylinder to an opening of a container; a piston slidably attached to the cylinder from inside; a nozzle head coupled to the piston; a second valve attached to a shaft portion of the nozzle head; a spring body inserted in the cylinder so as to elastically energize the nozzle head; and an intake valve which opens/closes a valve seat portion of the cylinder; the pump dispenser discharging liquid from a nozzle opening of the nozzle head by applying a pressure to the liquid filling the interior of the cylinder; wherein the wall of the cylinder has a thickness of 0.6 mm to 1.3 mm.

The present invention resides in (3) the pump dispenser according to above described (1), wherein many ribs are formed on the outer wall of the cylinder along an axial direction.

The present invention resides in (4) the pump dispenser according to above described (1), wherein a flange is formed on the outer wall of the cylinder in a direction perpendicular to an axial direction.

The present invention resides in (5) the pump dispenser according to above described (1), wherein the diameter of a receiver washer supporting a spring body is equal to the diameter of the cylinder.

The present invention resides in (6) the pump dispenser according to above described (1), wherein a lower tongue portion of a valve body of the piston is formed to be longer than an upper tongue portion.

The present invention resides in (7) the pump dispenser according to above described (1), wherein a suction tube having a reduced diameter is integrally attached to a lower portion of the cylinder, and the suction tube and the wall of the cylinder have the same thickness.

Note that constitutions which are arbitrary combinations of above described (1) to (7) can be also employed as long as they meet the object of the present invention.

### EFFECTS OF THE INVENTION

According to the present invention, since the thickness of the cylinder is reduced, the amount of resin serving as a material is reduced, and cost is also reduced.

Moreover, the “liquid leakage” and “air inclusion” phenomena do not occur.

Many ribs are formed on the outer wall of the cylinder along the axial direction. Therefore, deformation (bending, cross sectional deformation) of the cylinder is prevented.

The diameter of the receiver washer supporting the spring body is equal to the diameter of the cylinder. Therefore, deformation (bending, cross sectional deformation) of the cylinder is similarly prevented.

The lower tongue portion of the piston is formed to be longer than the upper tongue portion. Therefore, even when the cross section of the cylinder is deformed, the lower tongue portion is deformed along the inner wall surface of the cylinder so as to reliably achieve sealing.

### BEST MODES FOR CARRYING OUT THE INVENTION

Hereinafter, best modes for carrying out the present invention will be explained based on drawings.

FIG. 1 is a cross sectional view showing a pump dispenser according to an embodiment of the present invention, wherein (A) shows a state before a nozzle head 2 is pushed down, and (B) shows a state after the nozzle head 2 is pushed down.

Note that, when liquid is to be discharged from an opening of the nozzle head 2, the above described states of (A) and (B) are repeated.

The pump dispenser A has a cylinder 1 and a cap 3 for attaching the cylinder 1 to a container B.

Therefore, the pump dispenser A can be readily integrated with the container B by, for example, screwing the cap 3 to an opening B1 of the container (see FIG. 2).

Moreover, the pump dispenser A has a piston 4, which is slidably attached to the cylinder 1 from inside, and the nozzle head 2, which is coupled to the piston 4.

Note that a flange portion 14 at the upper end of the cylinder 1 fits and is fixed to the cap 3, and the cap is rotatable with respect to the cylinder 1.

The piston 4 has a tubular shaft portion 41, and the nozzle head 2 is coupled to the upper end of the shaft portion 41.

Moreover, two upper and lower tongue portions 42 and 43 are formed at the lower end of the shaft portion 41 of the piston 4.

When the piston 4 slides in the cylinder 1, the part between the cylinder 1 and the piston is reliably sealed by the lower tongue portion 42 and the upper tongue portion 43.

Moreover, a spring body 5 is attached to the cylinder 1 from inside so as to elastically energize the piston 4.

The shaft portion 41 of the piston 4 fits in the nozzle head 2. When part of the nozzle head 2 abuts the cap 3 from the upper side, downward movement is stopped.

This position is the lower limit of the movement of the nozzle head 2, i.e., the lower dead point of the piston 4.

Moreover, a stopper rib 44 is formed on a lower portion of the outer periphery of the shaft portion 41 of the piston 4. When the stopper rib 44 abuts the cap 3 from the lower side, upward movement is stopped.

This position is the upper limit of the movement, i.e., the upper dead point of the piston 4.

When the piston 4 moves downward by a certain distance between the upper dead point and the lower dead point in this manner, a pressure is applied to the liquid in the cylinder 1.

As a result, the liquid is discharged from the nozzle head 2 (specifically, a nozzle opening N of the nozzle head) via a second valve SV.

In the present invention, the liquid leakage phenomenon does not occur in such an action.

When the piston is moved upward by a certain distance, a negative pressure is generated in the cylinder 1, and the liquid in the container is sucked up via a suction tube 13.

In the present invention, the air inclusion phenomenon does not occur in such an action.

With respect to such upward/downward movement of the piston 4, the cross section of the cylinder 1 always maintains a constant circular shape without being deformed. Therefore, the liquid leakage phenomenon and the air inclusion phenomenon do not occur.

As shown in FIG. 3, the cylinder 1 has three levels of diameter, i.e., a large-diameter portion 11, a medium-diameter portion 12, and a small-diameter portion 13 (suction tube), and these portions have the same thickness and are integrated. As the material of this cylinder, polypropylene is preferably employed from the viewpoint of hardness.

In the present invention, even when the thickness thereof is reduced, deformation in the cross section does not occur at least in the large-diameter portion 11.

Among them, the part of the small-diameter portion 13 serves as the suction tube.

A first step portion 1A is formed at the boundary between the large-diameter portion 11 and the medium-diameter portion 12 of the cylinder 1, and a second step portion 1B is formed at the boundary between the medium-diameter portion 12 and the small-diameter portion 13 (i.e., the suction tube).

A valve seat portion 1B1 is formed at the second step portion 1B, and an intake valve FV which opens/closes the valve seat portion 1B1 is attached to the medium-diameter portion 12.

A receiver washer 6 is attached to the first step portion 1A.

The receiver washer 6 has a size so that the washer coheres to the wall surface of the large-diameter portion 11 of the cylinder 1, thereby preventing deformation in the cross section of the cylinder 1.

Therefore, even when a situation that causes deformation in the cross section of the cylinder 1 is generated for some reason, the receiver washer 6 serves as a safety means capable of handling it.

Meanwhile, other methods are also employed as the safety means that prevent deformation in the cross section of the cylinder 1.

FIG. 4 is a drawing showing the cylinder on which ribs are formed in order to prevent deformation in the cross section of the cylinder.

On the outer peripheral surface of the cylinder 1, the ribs R are formed in the axial direction thereof. Deformation in the cross section is prevented since the ribs R have a reinforcing function.

FIG. 5 is a drawing showing the cylinder on which flanges F are formed in order to prevent deformation in the cross section of the cylinder 1.

The flanges F are formed on the outer peripheral surface of the cylinder in the direction perpendicular to the axial direction thereof. The flanges F have a reinforcing function and prevent deformation in the cross section.

Incidentally, in the present invention, the lower tongue portion 42 of the piston 4 is formed to be longer than the upper tongue portion 43. Therefore, even when deformation occurs in the cross section of the cylinder, the upper tongue portion 43 is deformed along the inner wall surface of the cylinder, and a gap is not generated.

This is also a safety valve for deformation of the cylinder.

“Numerical Value Limitation”

In the present invention, the cylinder having a thickness limited to a thickness in a certain range is used.

As described above, the valve seat having a reduced diameter for abutting the valve of the intake valve FV is required to be formed in the cylinder. Therefore, a step is required at the boundary between the medium-diameter portion 12 and the small-diameter portion 13 (suction tube) of the cylinder 1.

In other words, the diameter of the suction tube 13 has to be smaller than the diameter of the medium-diameter portion 12 of the cylinder 1.

As described above, when a negative pressure or a positive pressure is generated in the cylinder 1 in a normal usage state, the cross section thereof is readily deformed if the thickness of the cylinder 1 is thin.

In other words, the “liquid leakage” phenomenon or the “air inclusion” phenomenon occurs.

In the present invention, based on such findings, the relations between the thickness of the cylinder 1, the diameter of the nozzle opening, the ratio between the diameter of the cylinder and the diameter of the nozzle opening, and the ratio between the diameter of the cylinder and the diameter of the suction tube are confirmed by experiments.

[Experiments]

In the pump dispensers (capacity: 2 liters, see FIG. 2) of the cases in which the cylinder [made of polypropylene, the amount of discharge: 20 cc/one push] had a thickness of 0.5 mm and an inner diameter of 28 mm, wherein the diameter of the nozzle opening and the diameter of the suction tube were 4 mm, 5 mm, 6 mm, 7 mm, 8 mm, and 9 mm, the piston was moved upward and downward, and water was discharged from the nozzle.

Also, in the pump dispensers (capacity: 2 liters, see FIG. 2) of the cases in which the cylinder [made of polypropylene, the amount of discharge: 20 cc/one push] had a thickness of 0.5 mm and an inner diameter of 18 mm, wherein the diameter of the nozzle opening and the diameter of the suction tube were 4 mm, 5 mm, 6 mm, 7 mm, 8 mm, and 9 mm, the piston was moved upward and downward, and water was discharged from the nozzle.

The experiments same as the above were carried out in the cases in which the thickness of the cylinder [made of polypropylene] was 0.5 mm, 0.6 mm, 0.7 mm, 0.8 mm, 0.9 mm, 1.0 mm, 1.1 mm, 1.2 mm, 1.3 mm, and 1.4 mm, respectively.

Results

Table 1 to Table 18 show the results of the experiments.

TABLE 1
CYLINDER THICKNESS (0.5 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | EXIST | EXIST | EXIST | EXIST | EXIST | EXIST |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 2
CYLINDER THICKNESS (0.6 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 3
CYLINDER THICKNESS (0.7 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 4
CYLINDER THICKNESS (0.8 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 5
CYLINDER THICKNESS (0.9 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 6
CYLINDER THICKNESS (1.0 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 7
CYLINDER THICKNESS (1.2 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 8
CYLINDER THICKNESS (1.3 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 9
CYLINDER THICKNESS (1.4 mm)
CYLINDER INNER DIAMETER ø (28 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/28 | 5/28 | 6/28 | 7/28 | 8/28 | 9/28 |

TABLE 10
CYLINDER THICKNESS (0.5 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | EXIST | EXIST | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 11
CYLINDER THICKNESS (0.6 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 12
CYLINDER THICKNESS (0.7 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 13
CYLINDER THICKNESS (0.8 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 14
CYLINDER THICKNESS (0.9 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 15
CYLINDER THICKNESS (1.0 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 16
CYLINDER THICKNESS (1.2 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 17
CYLINDER THICKNESS (1.3 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

TABLE 18
CYLINDER THICKNESS (1.4 mm)
CYLINDER INNER DIAMETER ø (18 mm) (A)

| NOZZLE OPENING INNER | ø4 | ø5 | ø6 | ø7 | ø8 | ø9 |
|---|---|---|---|---|---|---|
| DIAMETER ø (B) (mm) | | | | | | |
| SUCTION TUBE INNER | ø4 | ø5 | ø6 | ø7 | ø8 | ø9 |
| DIAMETER ø (C) (mm) | | | | | | |
| LIQUID LEAKAGE | NONE | NONE | NONE | NONE | NONE | NONE |
| AIR INCLUSION | NONE | NONE | NONE | NONE | NONE | NONE |
| DIAMETER RATIO (B/A, C/A) | 4/18 | 5/18 | 6/18 | 7/18 | 8/18 | 9/18 |

According to these results, regarding the minimum thickness of the cylinder wall (0.6 mm or more), it is proved that the “liquid leakage” phenomenon and the “air inclusion” phenomenon caused by deformation of the cylinder do not occur when the thickness is 0.6 mm or more.

Also, the maximum thickness of the cylinder wall (1.3 mm or less) is satisfactorily smaller than the thickness of a conventional cylinder wall (described above, 1.5 mm or more) even when a safety factor is multiplied by two in the case in which the thickness is 0.6 mm (see Table 2) and the case in which the thickness is 0.7 mm (see Table 3), wherein conditions are hard.

A similar thing also applies to the case of 0.6 mm (see Table 11) and the case of 0.7 mm (see Table 12).

Thus, advantages of the thickness of the cylinder wall being 0.6 mm to 1.3 mm were confirmed.

The present invention has been explained above. However, the present invention is not limited only to the above described embodiment, and various modifications can be made.

For example, although the case in which the material of the cylinder 2 is polypropylene has been shown, it was proved by experiments that almost all resin materials somewhat harder than polypropylene can be applied.

The pump dispenser is not limited to that shown in the drawings, and a pump dispenser having a cylinder and a piston are applicable in terms of principles.

### INDUSTRIAL APPLICABILITY

The present invention relates to a pump dispenser which discharges a certain amount of liquid in a container, and the thickness of the cylinder is reduced. Therefore, the amount of resin, which serves as a material, is reduced, and cost is also reduced.

The present invention is applicable to containers of other fluid jetting fields such as painting related to the push-type pump dispenser as long as the principles thereof are used, and the application field thereof is wide.

### BRIEF DESCRIPTION OF THE DRAWINGS

FIG. 1 is a cross sectional view showing a pump dispenser according to an embodiment of the present invention, wherein FIG. 1 (A) shows a state before a nozzle head is pushed down, and FIG. 1 (B) shows a state after the nozzle head is pushed down.

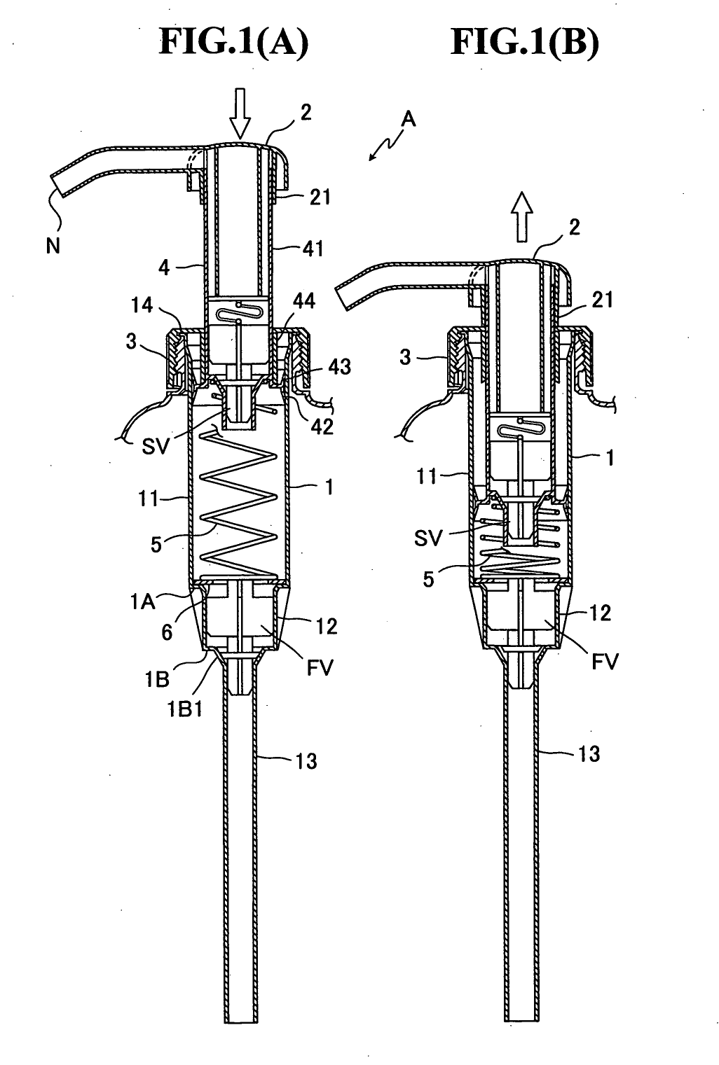

FIG. 2 is a drawing showing the pump dispenser attached to a container according to an embodiment of the present invention.

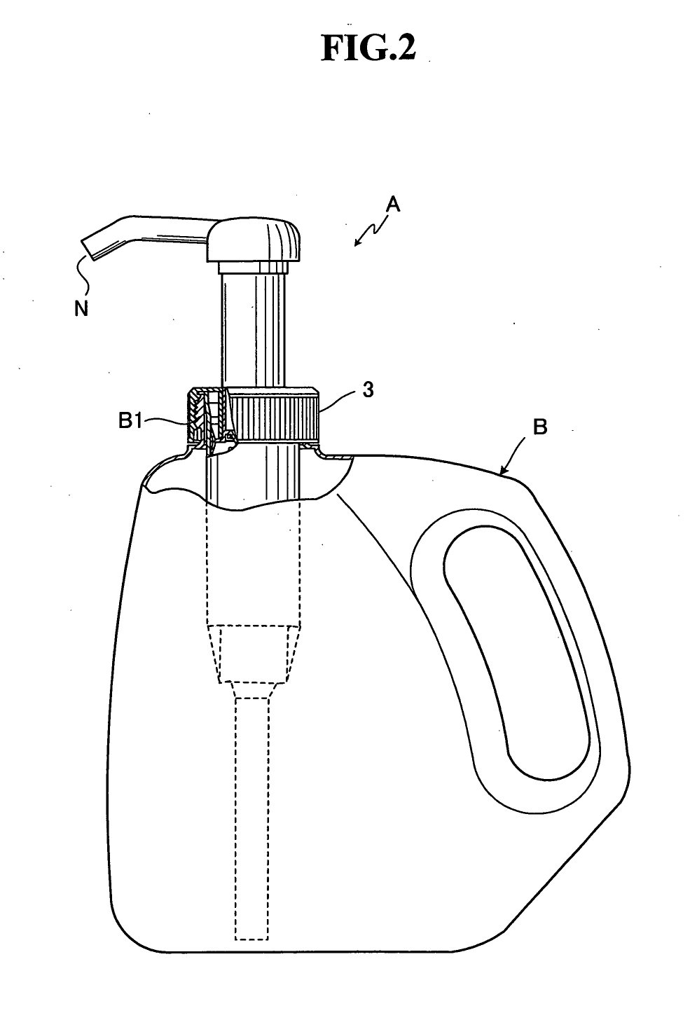

FIG. 3 is a perspective view showing a cylinder.

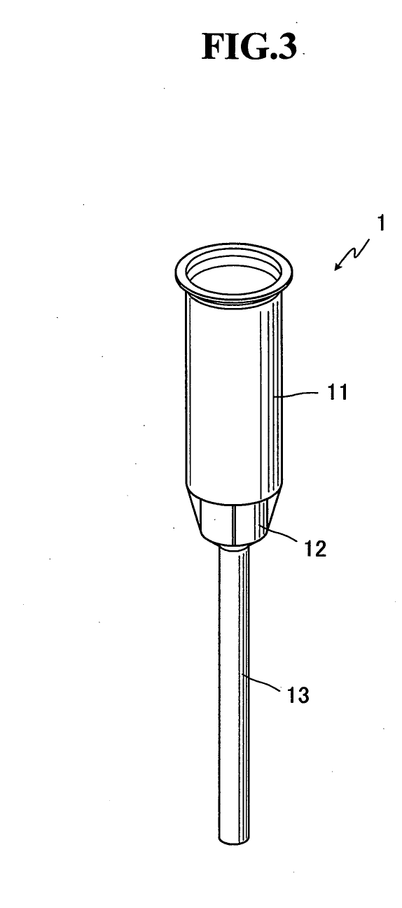

FIG. 4 is a perspective view showing a cylinder on which ribs are formed.

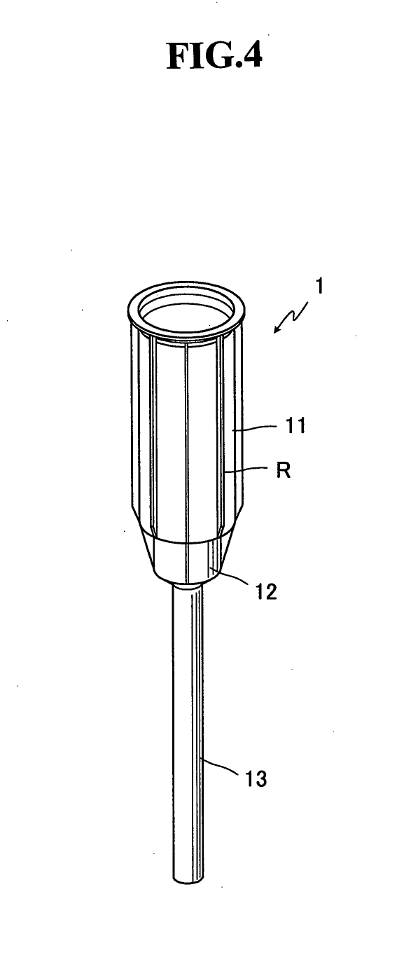

FIG. 5 is a perspective view showing a cylinder on which flanges are formed.

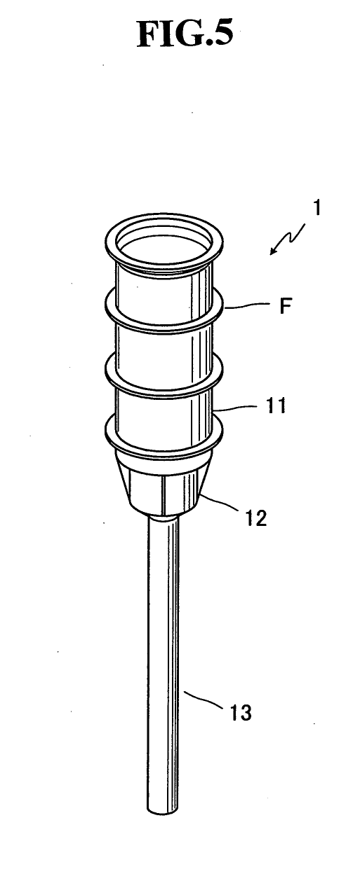

### DESCRIPTION OF REFERENCE NUMERALS

A Pump Dispenser
1 CYLINDER
11 LARGE-DIAMETER PORTION
12 MEDIUM-DIAMETER PORTION
13 SMALL-DIAMETER PORTION (SUCTION TUBE)
14 FLANGE PORTION
1A FIRST STEP PORTION
1B SECOND STEP PORTION
1B1 VALVE SEAT PORTION
2 NOZZLE HEAD
3 CAP
4 PISTON
41 SHAFT PORTION
42 LOWER TONGUE PORTION
43 UPPER TONGUE PORTION
44 STOPPER RIB
5 SPRING BODY
6 RECEIVER WASHER
B CONTAINER
B1 CONTAINER OPENING PART
F FLANGE
N NOZZLE OPENING
R RIB
FV INTAKE VALVE
SV SECOND VALVE

1. A pump dispenser comprising a cylinder and a piston slidably attached to the cylinder from inside, the pump dispenser discharging liquid from a nozzle head coupled to a piston by applying a pressure by the piston to the liquid filling the interior of the cylinder, characterized in that the wall of the cylinder has a thickness of 0.6 mm to 1.3 mm.

2. A pump dispenser comprising
a cylinder integrally having a suction tube;
a cap for attaching the cylinder to an opening of a container;
a piston slidably attached to the cylinder from inside;
a nozzle head coupled to the piston;
a second valve attached to a shaft portion of the nozzle head;
a spring body inserted in the cylinder so as to elastically energize the nozzle head; and
an intake valve which opens/closes a valve seat portion of the cylinder;
the pump dispenser discharging liquid from a nozzle opening of the nozzle head by applying a pressure to the liquid filling the interior of the cylinder; wherein
the wall of the cylinder has a thickness of 0.6 mm to 1.3 mm.

3. The pump dispenser according to claim 1, characterized in that
many ribs are formed on the outer wall of the cylinder along an axial direction.

4. The pump dispenser according to claim 1, characterized in that
a flange is formed on the outer wall of the cylinder in a direction perpendicular to an axial direction.

5. The pump dispenser according to claim 1, characterized in that
the diameter of a receiver washer supporting a spring body is equal to the diameter of the cylinder.

6. The pump dispenser according to claim 1, characterized in that
a lower tongue portion of a valve body of the piston is formed to be longer than an upper tongue portion.

7. The pump dispenser according to claim 1, characterized in that
a suction tube having a reduced diameter is integrally attached to a lower portion of the cylinder, and the suction tube and the wall of the cylinder have the same thickness.
